(19) United States
(12) Patent Application Publication
(10) Pub. No.: US 2006/0016552 A1
(43) Pub. Date: Jan. 26, 2006

(54) Electrofusion pipe-fitting joining system and method utilizing conductive polymeric resin

(75) Inventors: Riccardo E. Barbone, Maumelle, AR (US); Paul F. Mastro, Little Rock, AR (US); James Gilchrist, North Little Rock, AR (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: George Fischer Sloane, Inc., Little Rock, AR (US)

(21) Appl. No.: 10/894,974

(22) Filed: Jul. 20, 2004

(51) Int. Cl. B32B 37/00

(52) U.S. Cl. 156/272.2; 156/379.7

(57) ABSTRACT

A joining device for electrofusion of at least one end of a pipe to a fitting is provided which includes a fitting of a polymeric material and a collar adapted to receive the end of the pipe. The collar is fabricated from a conductive polymer composite material and positioned within the fitting. A connector for connecting the collar to a source of current may be provided which may be integral to the fitting. Likewise, the collar may be integral to the fitting. All three of the connector, collar and fitting are preferably an integral unit. A method of making the joining device and a method of using the joining device are also provided.

### BACKGROUND OF THE INVENTION

The present invention is generally directed to pipe joining methods. More particularly, the present invention is directed to pipe joining methods using electrofusion.

In the prior art, pipe fitting joining methods using electrofusion have utilized solid wire as a conductor to provide resistance heating. This wire is wound in various configurations such that the wire may be properly inserted in a pipe/fitting interface. FIG. 1A depicts one example of such a resistance wire. FIG. 1B shows the resistance wire of FIG. 1A as applied to a pipe connector. The current manufacturing methods in producing this “coil” are expensive, labor intensive and subject to human induced errors in fabrication and handling.

Moreover, current electrofusion joining methods that utilize wire may introduce contamination, particularly from the wire, into the fluid being conveyed in the piping system.

Electrofusion joining methods that utilize wire may also cause wire movement that may affect the integrity of the formed joint.

It would be beneficial to provide an ultra-pure, clean joining system which prevents contamination of the fluid being carried. For example, de-ionized water and other substances being carried in piping may require substantially no contamination that could affect chemical purity or electrical resistance.

Several patents teach use of electrofusion of saddle-type pipe fittings. For example, U.S. Pat. No. 5,321,233 (Barrett et al.) is directed to an electro-fusion pipe fitting. Current is applied to electrodes that are coupled to a conductor (disclosed as wire) for heating to temperatures sufficient to melt the piping adjacent the fitting.

Additionally, U.S. Pat. No. 5,388,869, (Suzuki et al.) discloses a saddle type pipe joint comprising a main pipe connecting part and a branching pipe connecting part. The two parts are integrally molded by reaction molding. On their inner surfaces, a fusion-bonding plastic resin layer contains a conductive filler. This patent cites Japanese unexamined Patent Publication No. H4-294115 in which an electro-fusion pipe joint is disclosed which includes a base body composed of a thermal setting resin and which is molded by reaction molding.

The electrically conductive filler may be carbon black. See col. 1-2. As seen in FIG. 9 of the Suzuki et al. patent, the saddle type pipe joint has a fusible plastic resin layer 29 made from the conductive material. Wires 49 are attached to electrodes 47 that are connected to the layer 29.

U.S. Pat. No. 6,193,834 (Smith) discloses an apparatus for fusing a pipe to a fitting which includes an induction heating sleeve element. The conductive material of the sleeve element may include conductive particles, such as a magnetic alloy powder mixed with a compatible polymeric material to form a sleeve shape. Current flows through the conductive material to fuse the pipe to the fitting.

U.S. Pat. No. 6,375,226 (Dickinson et al.) is directed to a pipe connector for a multi-layer composite pipe that uses fusion for connections. Fusion can be accomplished using a conductive filler in a fusible thermoplastic polymeric material. See column 5, lines 8 through 16.

European Patent No. 0 547 640 (Raychem Corp.) discloses a method for joining plastic pipes which makes use of a heat-shrinkable coupler which comprises a conductive polymer and which is heated to its shrinkage temperature by passing electrical current through the conductive polymer. The heating also causes fusion.

Other related patents include the following:

U.S. Pat. No. 5,138,136 (Moreau et al.) discloses an apparatus for supplying an electric current to a resistive heating element. In particular, this disclosure applies to supplying a signal to a resistive element of a connecting piece for electro-weldable plastic tubes. Note that at column 6, line 64, use of an electrically conductive polymer material is taught for a heating element. However, this particular embodiment is directed to a cable where the heating element is used to cause a heat shrink layer to shrink (and is not used for electro-fusion).

U.S. Pat. No. 5,988,689 (Lever) discloses a heat shrinkable electro-fusion fitting which includes an electrically heatable tubular plastic outer member, an electrically heatable tubular plastic inner member and an electrically activated induction coil positioned with respect to the outer and inner members for simultaneously energizing and causing the members to be heated for fusion. The outer member may include a conductive filler. In the Description of the Prior Art, this patent indicates that “electrofusion fittings have been developed and used which include particulate ferromagnetic and/or other conductive fillers. The fillers cause the entire fittings to be heated when the fillers are electrically energized.” See col. 1.

It would also be beneficial to have a system for using electrofusion which provides for quick and easy connection to a power source for transmission of current to the conductive polymer.

Finally, it would be beneficial to have a system for electrofusion that utilizes an integrated pipe socket joining system.

All references cited herein are incorporated herein by reference in their entireties.

### BRIEF SUMMARY OF THE INVENTION

A joining device for electrofusion of at least one end of a pipe to a fitting is provided which includes a fitting of a polymeric material and a collar adapted to receive the end of the pipe. The collar is fabricated from a conductive polymer composite material and positioned within the fitting. A connector for connecting the collar to a source of current may be provided which may be integral to the fitting. Likewise, the collar may be integral to the fitting. The connector may be integral to the collar and the fitting.

Alternatively, rather than using a connector, the collar may be adapted to receive external inductive current. The conductive polymer composite material is preferably a blend of a plastic substrate material and a conductive material. The conductive polymer composite material may include, for example, carbon nanotubes or graphite. The fittings may be fabricated from, for example, polypropylene or polyvinylidene fluoride, polyamide or polyvinylchloride.

A method of fabricating a device for joining at least one pipe to the device is provided where the device is capable of electrofusion of at least one end of a pipe. The method includes the steps of providing a fitting of a polymeric material and providing a collar adapted to receive the end of the pipe. The collar is fabricated from a conductive polymer composite material and is positioned withing the fitting. A step may be included of co-injection molding the fitting and collar as a single integral unit. This may also be accomplished, for example, by an insert molding process. The fitting and collar may also be separately molded and subsequently fitted together to form the device for joining.

Finally, a method of joining an end of a pipe to a fitting is provided which includes the steps of providing a fitting of a polymeric material that is capable of being bonded by melting to the pipe and providing a collar adapted to receive the end of the pipe. The collar is fabricated from a conductive polymer composite material of a similar material to the polymeric material of the fitting and pipe and is capable of being bonded by melting to the fitting and pipe. Electrical current is passed through the collar such that heat caused by the electrical current at least partially melts the fitting and pipe causing the fitting to fuse to the end of the pipe. Further steps of providing a connector for connecting the collar to a source of current and passing the electrical current through the collar via the connector may also be provided. Alternatively, the step of passing electrical current through the collar may include providing external inductive current.

### BRIEF DESCRIPTION OF SEVERAL VIEWS OF THE DRAWINGS

The invention will be described in conjunction with the following drawings in which like reference numerals designate like elements and wherein:

FIG. 1A is a front elevation view of a prior art “coil,” i.e., a metal wire resistive element, for use in electrofusion connections in piping systems;

FIG. 1B is an isometric view of the prior art coil of FIG. 1A shown installed in a pipe fitting.

FIG. 2 is a cross-section elevation view of a joining device for electrofusion of at least one end of a pipe to a fitting, the fitting having two collars of a conductive composite polymer material integral to the pipe fitting in accordance with one preferred embodiment of the present invention;

FIG. 3 is a cross-section elevation detail view of the joining of FIG. 2, as indicated by Detail A in FIG. 2;

FIG. 4 a front elevation view of an integrated connector pin integral to the pipe fitting of FIG. 2;

FIG. 5 is a side, elevation view of an alternate joining device in accordance with the present invention;

FIG. 6 is an isometric view of a collar of the joining device of FIG. 2;

FIG. 7 is an isometric view of the joining device of FIG. 2;

FIG. 8 is a cross-section, elevation view of an alternate embodiment of the joining device of FIG. 2;

FIG. 9 is a simplified cross-section view of a joining device in accordance with the present invention depicting a “fusion zone” showing the approximate area where pipe material and fitting material have melted and bonded adjacent to the collar; and

FIG. 10 is detail view of the fusion zone of FIG. 9.

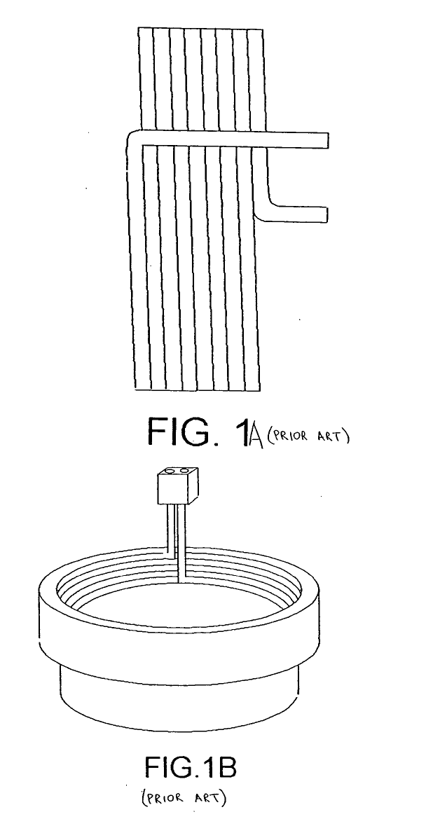

### DETAILED DESCRIPTION OF THE INVENTION

The present invention is directed to electrically conductive plastics in which a blend of plastic resin and conductive substrate (the conductive polymer composite material) is injection molded, for example, co-injection molded, into an appropriate shape for the purpose of fusion of two or more plastic components (such as an end of a pipe to a pipe fitting). Electrical current is passed through the conductive polymer composite material whereby resistance caused in the conductive polymer composite material heats and thereby fuses the two or more plastic components. The conductive polymer composite material is placed between the components being fused and is in the form of a collar. Variations may be made, for example, in the percent concentration of conductive materials (such as nano-conductive materials) present in the composite material, and the dielectric properties of the composite material. A higher percentage of conductive material in the composite material creates a lower resistivity.

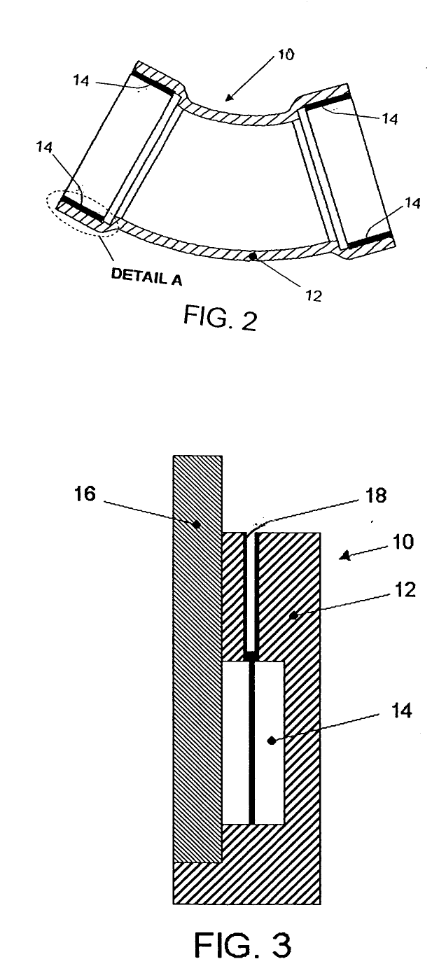

Referring now to the figures, wherein like part numbers refer to like elements throughout the several views, there is shown in FIG. 2, a cross-sectional elevation view of a joining device 10 for electrofusion of at least one end of a pipe 16 to a fitting in accordance with one preferred embodiment of the present invention. For clarity sake, the elements noted by various call-outs herein are shown in several configurations throughout the views. However, the function of the elements does not change from figure to figure. The joining device 10 includes two primary components, a fitting of a polymeric material 12 and a collar 14 adapted to receive the end of the pipe 16. The collar 14 is fabricated from a conductive polymer composite material as will be described below. As can best be seen in FIGS. 2, 3, 5 and 7, the collar 14 is positioned within the fitting 12. The collar 14 is preferably injection molded into an annular shape allowing it to be integrally placed between adjacent plastic surfaces to be bonded, i.e., an end of a pipe 16 and the fitting 12.

Preferably, electrically connected to the collar 14 is a connector 18 for connecting the collar 14 to a source of current. The connector 18 and collar 14 are preferably integral to the fitting 12.

Alternatively, rather than using connector 18 (or wires directly embedded in the collar 14, not shown), a connectorless system may be used with the use of externally applied inductive current. Here, the conductive polymer composite material is subjected to an indirect external current source using inductance where, for example, a magnetic apparatus (not shown) is placed around the fitting and the magnetic field generates the current flow through the conductive polymer composite material). Heat is generated by internal resistance providing delivery of heat energy to the surrounding area, thereby bonding the adjacent surfaces.

The material of the collar 14 is a blend of a plastic substrate and an electrically conductive material. The electrically conductive material may be, for example, carbon nanotubes or graphite. This material will be described in further detail below.

Typical desirable dimensions for a two inch outer diameter collar may be, for example, approximately 0.4 inches plus or minus 0.3 inches (or more preferably about 0.1 inches) by about 0.8 inches plus or minus 0.3 inches (or more preferably about 0.1 inches). Of course, these dimensions may vary greatly depending, for example, on the size of the piping and fittings to be joined.

Preferably, the shape and design of the collar 14 will be such that it can be readily integrated into pipe/fitting joining applications that presently exist.

The present invention includes three basic components: the material (i.e., the conductive polymer composite material), the manufacturing process, and the design concept. These three components will each be discussed below.

### The Conductive Polymer Composite Material

The conductive polymer composite material for use in the collar 12 is a composite mixture based on a percentage of a similar substrate material to the pipe and fittings which are to be fused. Examples of these substrate materials are polyolefins such as polypropylene (PP) or flame retardant polypropylene (PPFR), polyvinylidene fluoride (PVDF), polyethylene (PE) or PA11. The composite mixture also includes a percentage of electrically conductive raw material that is injection moldable. Example of such materials are graphite and carbon nano-tubes.

The collar 12 of the conductive polymer composite material must have similar polymeric properties to that of the pipe fitting 14. Having such similar properties will allow the joint/weld to be uniform and form a solid fluid barrier, that is, bond the pipe and fitting together. Important properties include minimal voids, uniform material dispersion, uniform packing density, and uniformly distributed resistance properties (e.g., ±5%).

A non-limiting example of a composite polypropylene material that provides satisfactory results is as follows:

COMPOUND PROPERTIES:

| | | |
|---|---|---|
| Injection Pressure | 10,000-15,000 | psi |
| Injection Cylinder Temperature | 380-440 | degrees Fahrenheit |
| Mold Temperature | 90-150 | degrees Fahrenheit |

MOLDED PRODUCT PROPERTIES

| | | | |
|---|---|---|---|
| Specific Gravity | 1.05 | | ASTM D-792 |
| Mold Shrinkage | 0.010-0.015 | in/in | ASTM D-955 |

MECHANICAL

| Impact Strength (IZOD) | | | |
|---|---|---|---|
| Notched ⅛ in. | 13 | ft. lbs./in. | ASTM D-256 |
| Unnotched ⅛ in. | No break | | |
| Tensile Strength | 10+% | | ASTM D-638 |
| Tensile Modulus | 0.13 | psi × 10⁸ | ASTM D-638 |
| Flexural Strength | 5000 | psi | ASTM D-790 |
| Flexural Modulus | 0.15 | psi × 10⁶ | ASTM D-790 |

ELECTRICAL

| | | | |
|---|---|---|---|
| Volume Resistivity | max 5 | ohm-cm | ASTM D-257 |
| Surface Resistivity | max 1000 | ohm/sq. | ASTM D-257/S11.11 |
| Surface Resistance | max 100 | ohms | ASTM S11.11 |

THERMAL

| | | | |
|---|---|---|---|
| Flammability | HB @ 1/16 | in. | ASTM D-635 |

It is noted that these values are merely examples of values for an example of a composite material that provides appropriate properties. The present invention is not intended to be limited to any particular material, so long as the composite material, as used in the present invention, is capable of generating sufficient heat energy to bond pipe and fitting into a sealed joint.

### Manufacturing Process

The manufacturing process utilizes current technology, as well known in the art of molding polymeric materials, including insert molding and co-injection molding.

A primary element of the present invention is integration of the collar 14 into the fitting 14. For purposes of the present invention, the term “fitting” is intended to broadly include all types of fittings, sockets, caps and other piping connection elements.

One tool may be used to mold both the conductive collar 14 and the fitting 12 in a single co-injection molding operation. Alternatively, molding of the collar 14 may be accomplished separately from the molding of the molding of the fitting 12. Here, the collar 14 is first molded in a separate tool. The conductive collar is then loaded on to a fitting molding tool where the fitting is molded around the collar 14. This type of manufacturing is known as “insert-molding” or “over-molding.” In yet another alternative process, the collar 14 is molded in one tool, a fitting 12 is molded in a second tool, and the collar 14 is hand or machined loaded into the previously molded fitting.

The optimal manufacturing configuration is one where the collar 14 is injection molded and in the same tool the surrounding fitting 12 material is molded, thus encapsulating the collar 14. As indicated, this can be accomplished by co-injection molding or insert-molding.

Control of molding parameters is critical in that uniformity of electrical properties of the collar 14 throughout the collar 14 will only be achieved by tight processing conditions. For example, temperatures within ±2 degrees Fahrenheit and mold pressures within ±50 psi may be required. Due to the brittleness and hardness of the highly filled conductive polymer composite material, mold temperature control is very critical to achieve a desirable set of properties. As indicated above, temperature controls may be required to be in the range of ±2 degrees Fahrenheit. However, these requirements are material specific and may need to be optimized for alternate materials. In an example as tested, mold barrel temperatures were 480 to 500 degrees Fahrenheit and back pressures was about 225 psi with a screw speed of 50 feet per minute.

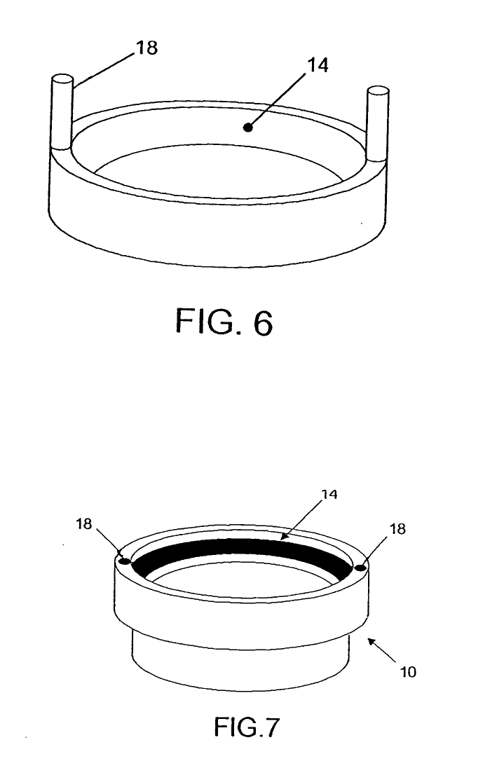

The design, geometry and shape of the collar 14, as shown in FIG. 6, effectively distributes the heat energy radially outwardly to enable uniform heating and melting of the adjacent surfaces.

In a typical example, the power requirements to obtain good results may be, for example, approximately 50 watts with the resistance of the band being about 22 ohms (requiring 32 volts at 1.5 amps). A fusion time of, for example, 100 seconds would give 5000 joules of energy.

The methods for fabricating the device are as follows. First, both the collar 14 and fitting 12 may be co-injection molded in one tool in one operation into an appropriate shape. Alternatively, molding of the collar 14 may be accomplished separately from the molding of the molding of the fitting 12. Here, the collar 14 is first molded in a separate tool. The conductive collar is then loaded on to a fitting molding tool where the fitting is molded around the collar 14. In yet another alternative process, the collar 14 is molded in one tool, a fitting 12 is molded in a second tool, and the collar 14 is hand or machined loaded into the previously molded fitting.

### Design Concept

The present invention is directed to an integrated pipe joining system that utilizes a collar made from a conductive polymer composite material that is located inside the fitting. The fitting used does not utilize a coil, as a method of generating a fusion joint.

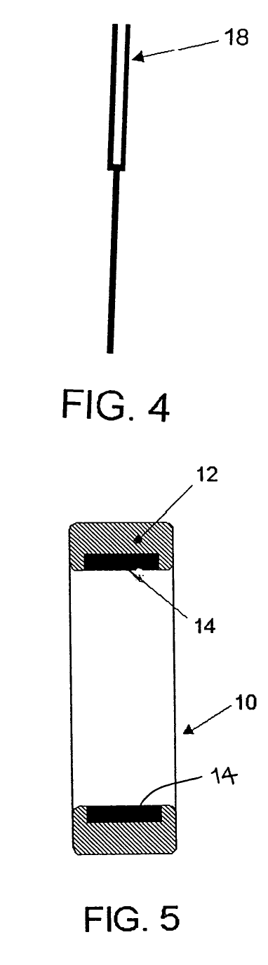

Electrical current is supplied to the conductive collar a connector 18, for example, in the form of conductor pins 20 or any other means of delivering current, direct, or indirect, such as inductive heating, using a magnetic coil, and the like. See, e.g., FIGS. 3, 4 and 8.

The most desirable shape for the collar 14 is an annular shape as shown in FIG. 6. The fitting 12 material wall thickness should be such that there is a sufficient wall to enable the fusion zone 22 (see FIGS. 9 and 10) to adequately surround the collar 14. Testing has shown that a typical fusion zone 22 thickness may be approximately 0.050 to 0.070 inches. The collar 14 was found to yield good results when dimensioned as approximately 0.4 inches ±0.1 inches (wide) by 0.080±0.010 inches thick.

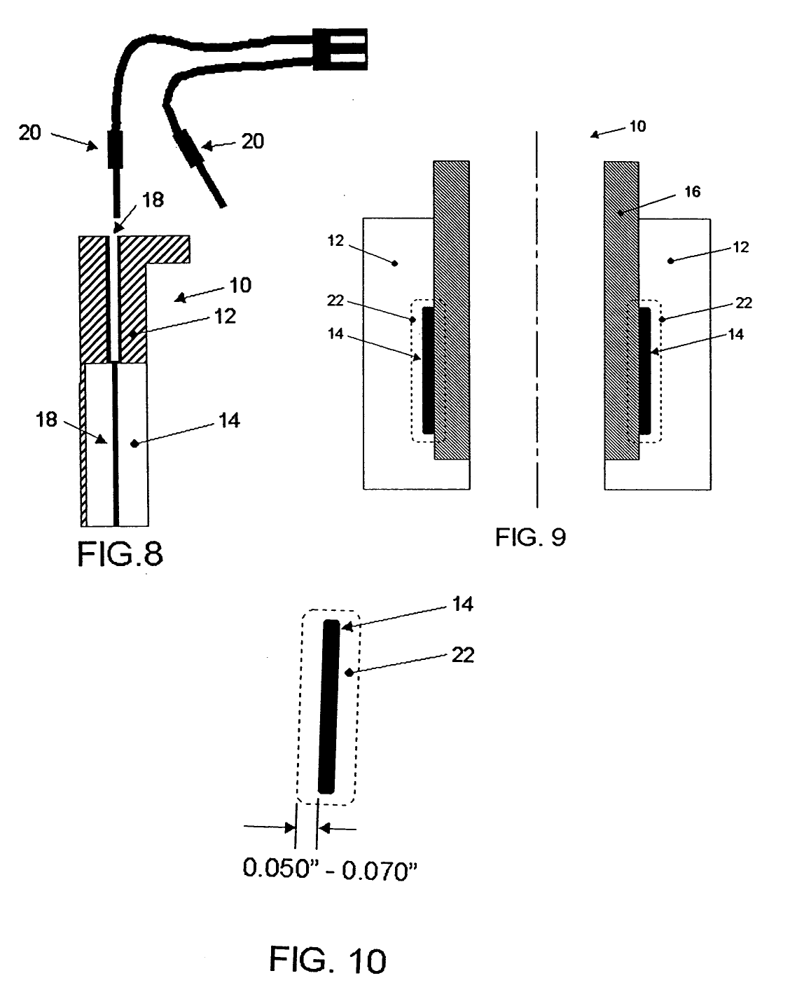

In the present invention it is also desirable to use an integrated connector 18 design, as shown, for example, in FIGS. 3 and 8. The connector 18 design may be connector pins 20 to allow for the transmission of electrical current into the conductive collar.

As indicated above, most current electrofusion methods for piping utilize conductive wire in the fitting-pipe interface. This wire, sometimes called the “coil,” is subjected to electrical current thereby heating the surrounding surfaces, creating a permanent bond. The present invention would greatly simplify the manufacturing method by allowing the “coil” to be replaced by the injection moldable collar 14, which could be introduced into the fitting 12 by the various means noted above (insert molding, co-injection molding, and the like). The device and method of the present invention uses the collar 14 which replaces the commonly used “coil” method.

The present invention would benefit applications that require an ultra-pure/clean joining method which prevents contamination of the carrier fluid, e.g., de-ionized water or other substance requiring no contamination, since no conductive wire is used. No wire movement would improve the integrity of the joints where, prior to the present invention coil wire movement could cause improperly formed joints.

The ability to injection mold a conductive collar 14 with properties that allow it to melt and transfer heat energy has many advantages including greatly reduced manufacturing costs, and a high quality integrated product that yields high quality repeatable joints.

In the operation of joining an end of the pipe to the fitting 12, the fitting 12 is provided that is capable of being bonded by melting to the pipe. The collar 14 is provided that is adapted to receive the end of the pipe 16. The collar 14 is fabricated from a conductive polymer composite material that is of a similar material to the polymeric material of the fitting and pipe and that is capable of being bonded by melting to the fitting and pipe. The collar is preferably integral to the fitting. Electrical current is passed through the collar 14 such that heat caused by the electrical current at least partially melts the fitting 12 and pipe 16 causing the fitting to fuse to the end of the pipe 16.

While the invention has been described in detail and with reference to specific embodiments thereof, it will be apparent to one skilled in the art that various changes and modifications can be made therein without departing from the spirit and scope thereof.

We claim:

1. A joining device for electrofusion of at least one end of a pipe, comprising:
(A) a fitting of a polymeric material; and
(B) a collar adapted to receive the end of the pipe, the collar fabricated from a conductive polymer composite material and positioned within the fitting.

2. The joining device of claim 1, including a connector for connecting the collar to a source of current.

3. The joining device of claim 2, wherein the connector is integral to the fitting.

4. The joining device of claim 1, wherein the collar is integral to the fitting.

5. The joining device of claim 4, wherein the connector is integral to the collar and the fitting.

6. The joining device of claim 1, wherein the collar is adapted to receive external inductive current.

7. The joining device of claim 1 wherein the conductive polymer composite material is a blend of a plastic substrate material and a conductive material.

8. The joining device of claim 1, wherein the conductive polymer composite material comprises carbon nanotubes.

9. The joining device of claim 1, wherein the conductive polymer composite material comprises graphite.

10. The joining device of claim 1, wherein the fitting is fabricated from polypropylene.

11. The joining device of claim 1, wherein the fitting is fabricated from polyvinylidene fluoride.

12. The joining device of claim 1, wherein the fitting is fabricated from polyamide.

13. The joining device of claim 1, wherein the fitting is fabricated from polyvinyl chloride.

14. A method of fabricating a device for joining at least one pipe to the device, the device capable of electrofusion of at least one end of a pipe, comprising the steps of:
(A) providing a fitting of a polymeric material; and
(B) providing a collar adapted to receive the end of the pipe, the collar fabricated from a conductive polymer composite material, the collar positioned withing the fitting.

15. The method of claim 14, including the step of co-injection molding the fitting and collar as a single integral unit

16. The method of claim 14, wherein the collar is first molded, the collar is loaded on a fitting molding tool, and the fitting having the integral collar is molded in the fitting molding tool.

17. The method of claim 14, wherein the collar and fitting are separately molded and, subsequently are fitted together to form the device for joining.

18. The method of claim 14, including the step of providing a connector for connecting the collar to a source of current.

19. The method of claim 18, wherein the step of providing the connector includes fabricating a connector that is integral to the fitting.

20. The method of claim 18, including the step of fabricating the collar integral to the fitting.

21. The method of claim 18, including the step of fabricating the connector integral to the collar and the fitting.

22. The method of claim 18, wherein the step of providing the collar of the conductive polymer composite material includes providing a collar that is a blend of a plastic substrate material and a conductive material.

23. The method of claim 14, wherein the step of providing a collar fabricated from a conductive polymer composite material, includes fabricating from a material comprising carbon nanotubes.

24. The method of claim 14, wherein the step of providing a collar fabricated from a conductive polymer composite material, includes fabricating from a material comprising graphite.

25. The method of claim 14, wherein the step of providing the fitting of a polymeric material fitting includes providing the fitting of polyamide.

26. The method of claim 14, wherein the step of providing the fitting of a polymeric material fitting includes providing the fitting from polyvinyl chloride.

27. A method of joining an end of a pipe to a fitting comprising the steps of:
(A) providing a fitting of a polymeric material that is capable of being bonded by melting to the pipe; and
(B) providing a collar adapted to receive the end of the pipe, the collar fabricated from a conductive polymer composite material, the composite material being of a similar material to the polymeric material of the fitting and pipe and that is capable of being bonded by melting to the fitting and pipe, the collar being integral to the fitting.
(C) passing electrical current through the collar such that heat caused by the electrical current at least partially melts the fitting and pipe causing the fitting to fuse to the end of the pipe.

28. The method of claim 27, including the steps of providing a connector for connecting the collar to a source of current and passing the electrical current through the collar via the connector.

29. The method of claim 27, wherein the step of passing electrical current through the collar includes providing external inductive current.
